(19) United States
(12) Patent Application Publication
(10) Pub. No.: US 2022/0078831 A1
(43) Pub. Date: Mar. 10, 2022

(54) METHOD AND DEVICE IN NODES USED FOR WIRELESS COMMUNICATION

(71) Applicants: Jin LIU, SHANGHAI (CN); Xiaobo ZHANG, SHANGHAI (CN)

(72) Inventors: Jin LIU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/529,297

(22) Filed: Nov. 18, 2021

Related U.S. Application Data
(63) Continuation of application No. PCT/CN2020/091081, filed on May 19, 2020.

(30) Foreign Application Priority Data
Jun. 5, 2019 (CN) 201910484934.X

(51) Int. Cl. H04W 72/12; H04W 72/04; H04W 4/40; H04L 5/00

(52) U.S. Cl. CPC H04W 72/1278; H04W 72/0406; H04W 76/28; H04L 5/0055; H04W 4/40

(57) ABSTRACT

The present disclosure provides a method and device in nodes used for wireless communication. A first node receives a first signaling; transmits a second signaling, drops transmitting a first signal on a first radio resource block; or, drops transmitting a second signaling, transmits a first signal on a first radio resource block; the first signaling is used for a request for transmitting the first signal on the first radio resource block; and the first signaling is used to indicate a first radio resource block. Since a working status of the first node is timely informed, the present disclosure effectively solves the communication problems between peer nodes in the distributed system, thus reducing unnecessary signaling overhead and resource waste.

### CROSS REFERENCE TO RELATED APPLICATIONS

This application is a continuation of International Application No. PCT/CN2020/091081, filed May 19, 2020, claims the priority benefit of Chinese Patent Application No. 201910484934.X, filed on Jun. 5, 2019, the full disclosure of which is incorporated herein by reference.

### BACKGROUND

### Technical Field

The present disclosure relates to transmission methods and devices in wireless communication systems, and in particular to a sidelink-related transmission scheme and device in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In response to rapidly growing Vehicle-to-Everything (V2X) traffic, 3GPP has started standards setting and research work under the framework of NR. Currently, 3GPP has completed planning work targeting 5G V2X requirements and has included these requirements into standard TS22.886, where 3GPP identifies and defines 4 major Use Case Groups, covering cases of Vehicles Platooning, supporting Extended Sensors, Advanced Driving and Remote Driving. At 3GPP RAN#80 Plenary, the technical Study Item (SI) of NR V2X was initialized, and later at the first AdHoc conference of RANI 2019 it was generally agreed that the pathloss between a transmitter and a receiver in a V2X pair shall be taken as reference for the V2X transmitting power.

### SUMMARY

Compared with the existing LTE V2X system, NR V2X has a notable feature in supporting groupcast and unicast as well as supporting Hybrid Automatic Repeat Request (HARQ) function. In the traditional cellular system, a base station has full control capability over a User Equipment (UE) accessing to network, and the UE fully carries out an indication transmitted by the base station. While in V2X system, a relation between vehicles are equal and there is no subordinate relation. Therefore, UE B may not carry out an indication or a request transmitted by UE A. For example, resources specified by the UE A are unavailable to the UE B, or a working status of the UE B is not transparent to the UE A. In the case that the UE A is not informed, the UE A may transmit an indication to the UE B again, which results in signaling overhead and resource waste, and at the same time, request of the UE A is delayed. As the application of distributed systems becomes increasingly widespread, there are more cases in which a UE does not carry out a received instruction.

To solve the above problem, the present disclosure provides a solution for sidelink feedback, which effectively solves communication problems between peer nodes in a distributed system. It should be noted that the embodiments in a UE in the present disclosure and characteristics of the embodiments may be applied to a base station if no conflict is incurred, and vice versa. And the embodiments in the present disclosure and the characteristics in the embodiments can be arbitrarily combined if there is no conflict. Though originally targeted at single-carrier communications, the present disclosure is also applicable to multicarrier communications, and though the present disclosure is originally for single-antenna communications, the present disclosure is also applicable to multi-antenna communications.

The present disclosure provides a method in a first node for wireless communications, comprising:

receiving a first signaling;

transmitting a second signaling, dropping transmitting a first signal on a first radio resource block; or,

dropping transmitting a second signaling, transmitting a first signal on a first radio resource block;

herein, the first signaling is used for a request for transmitting the first signal on the first radio resource block; and the first signaling is used to indicate a first radio resource block.

In one embodiment, a problem to be solved in the present disclosure is: the first node cannot carry out the received first signaling.

In one embodiment, a method in the present disclosure is: by introducing the second signaling, a working status of the first node can be informed in time.

In one embodiment, the above method is characterized in that the second signaling is used to indicate that the first signaling is correctly received.

In one embodiment, the above method is characterized in that the second signaling is used for the first node not executing a request in the first signaling.

In one embodiment, the above method is advantageous in reducing signaling overhead and unnecessary resource waste.

In one embodiment, the above method is advantageous in that the request in the first signaling can be solved in time by other means.

The present disclosure provides a method in a first node for wireless communications, comprising:

receiving a first signaling; and

transmitting a second signaling, dropping transmitting a first signal on a first radio resource block;

herein, the first signaling is used for a request for transmitting the first signal on the first radio resource block; and the first signaling is used to indicate a first radio resource block.

The present disclosure provides a method in a first node for wireless communications, comprising:

receiving a first signaling; and

dropping transmitting a second signaling, transmitting a first signal on a first radio resource block;

herein, the first signaling is used for a request for transmitting the first signal on the first radio resource block; and the first signaling is used to indicate a first radio resource block.

According to one aspect of the present disclosure, the above method is characterized in comprising:

determining whether the first signal is transmitted on the first radio resource block;

herein, when it is determined to transmit the first signal on the first radio resource block, the second signaling is not transmitted; and when it is determined to drop transmitting the first signal on the first radio resource block, the second signaling is transmitted.

According to one aspect of the present disclosure, the above method is characterized in that the second signaling is used to indicate that the first signaling is correctly received.

According to one aspect of the present disclosure, the above method is characterized in comprising:

transmitting the first signal on a second radio resource block;

herein, the second signaling comprises first control information, the first control information is used to indicate a second radio resource block, and the second radio resource block is different from the first radio resource block.

According to one aspect of the present disclosure, the above method is characterized in that the first node is a UE.

According to one aspect of the present disclosure, the above method is characterized in that the first node is a base station.

According to one aspect of the present disclosure, the above method is characterized in that the first node is a relay node.

The present disclosure provides a method in a second node for wireless communications, comprising:

transmitting a first signaling; and

receiving a second signaling, or, receiving a first signal on a first radio resource block;

herein, the first signaling is used for a request for transmitting the first signal on the first radio resource block; and the first signaling is used to indicate a first radio resource block.

According to one aspect of the present disclosure, the above method is characterized in comprising:

when the second signaling is received, dropping receiving the first signal on the first radio resource block.

According to one aspect of the present disclosure, the above method is characterized in comprising:

when the second signaling is received, dropping a re-request for transmitting the first signal.

According to one aspect of the present disclosure, the above method is characterized in that the second signaling is used to indicate that the first signaling is correctly received.

According to one aspect of the present disclosure, the above method is characterized in comprising:

receiving the first signal on a second radio resource block;

herein, the second signaling comprises first control information, the first control information is used to indicate a second radio resource block, and the second radio resource block is different from the first radio resource block.

According to one aspect of the present disclosure, the above method is characterized in that the second node is a UE.

According to one aspect of the present disclosure, the above method is characterized in that the second node is a base station.

According to one aspect of the present disclosure, the above method is characterized in that the second node is a relay node.

The present disclosure provides a first node for wireless communications, comprising:

a first receiver, receiving a first signaling; and

a first transmitter, transmitting a second signaling, dropping transmitting a first signal on a first radio resource block; or, the first transmitter, dropping transmitting a second signaling, and transmitting a first signal on a first radio resource block;

herein, the first signaling is used for a request for transmitting the first signal on the first radio resource block; and the first signaling is used to indicate a first radio resource block.

The present disclosure provides a first node for wireless communications, comprising:

a first receiver, receiving a first signaling; and

a first transmitter, transmitting a second signaling, and dropping transmitting a first signal on a first radio resource block;

herein, the first signaling is used for a request for transmitting the first signal on the first radio resource block; and the first signaling is used to indicate a first radio resource block.

The present disclosure provides a first node for wireless communications, comprising:

a first receiver, receiving a first signaling; and

a first transmitter, dropping transmitting a second signaling, and transmitting a first signal on a first radio resource block;

herein, the first signaling is used for a request for transmitting the first signal on the first radio resource block; and the first signaling is used to indicate a first radio resource block.

The present disclosure provides a second node for wireless communications, comprising:

a second transmitter, transmitting a first signaling; and

a second receiver, receiving a second signaling, or, the second receiver receiving a first signal on a first radio resource block;

herein, the first signaling is used for a request for transmitting the first signal on the first radio resource block; and the first signaling is used to indicate a first radio resource block.

In one embodiment, the present disclosure is advantageous in the following aspects:

by introducing the second signaling in the present disclosure, a working status of the first node is informed in time.

the second signaling in the present disclosure is used to indicate that the first signaling is correctly received.

the second signaling in the present disclosure is used for the first node not executing a request in the first signaling.

the present disclosure reduces signaling overhead and unnecessary resource waste.

the request in the first signaling in the present disclosure can be solved in time by other means.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of the processing of a first node according to one embodiment of the present disclosure;

FIG. 2 illustrates a schematic diagram of a network architecture according to one embodiment of the present disclosure;

FIG. 3 illustrates a schematic diagram of a radio protocol architecture of a user plane and a control plane according to one embodiment of the present disclosure;

FIG. 4 illustrates a schematic diagram of a first communication device and a second communication device according to one embodiment of the present disclosure;

FIG. 5 illustrates a flowchart of radio signal transmission according to one embodiment of the present disclosure;

FIG. 6 illustrates a flowchart of radio signal transmission according to one embodiment of the present disclosure;

FIG. 7 illustrates a flowchart of determining whether a first signal is transmitted on a first radio resource block according to one embodiment of the present disclosure;

FIG. 8 illustrates a schematic diagram of a time-frequency resource unit according to one embodiment of the present disclosure;

FIG. 9 illustrates a schematic diagram of relations among antenna ports and antenna port groups according to one embodiment of the present disclosure;

FIG. 10 illustrates a structure block diagram of a processing device in a first node according to one embodiment of the present disclosure;

FIG. 11 illustrates a structure block diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

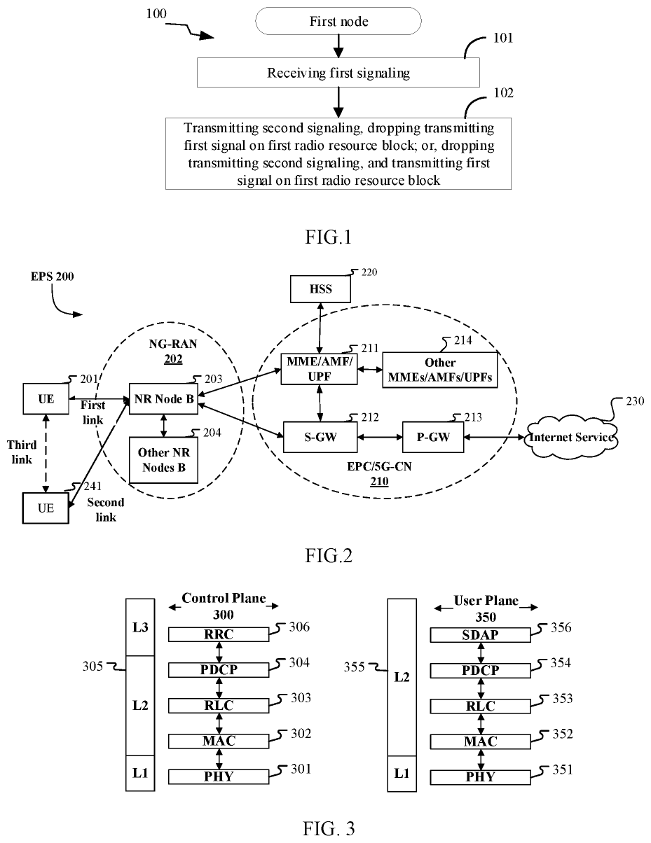

Embodiment 1 illustrates a flowchart of the processing of a first node according to one embodiment of the present disclosure, as shown in FIG. 1. In FIG. 1, each block represents a step. In embodiment 1, in step S101, a first node in the present disclosure first receives a first signaling; then in step 102, transmits a second signaling, drops transmitting a first signal on a first radio resource block; or, drops transmitting a second signaling, transmits a first signal on a first radio resource block; the first signaling is used for a request for transmitting the first signal on the first radio resource block; and the first signaling is used to indicate the first radio resource block.

In one embodiment, the first signaling is used to transmit scheduling information.

In one embodiment, the first signaling is used to transmit signal trigger information.

In one embodiment, the first signaling is used for a request for transmitting the first signal.

In one embodiment, the first signaling is used for a request for transmitting the first signal on the first radio resource block.

In one embodiment, the first signaling is used to schedule the first signal.

In one embodiment, the first signaling is used to schedule transmitting the first signal on the first radio resource block.

In one embodiment, the first signaling comprises scheduling information of the first signal.

In one embodiment, the first signaling is used to indicate the first radio resource block.

In one embodiment, the first signaling is used to indicate a time-domain resource unit occupied by the first radio resource block.

In one embodiment, the first signaling is used to indicate a frequency-domain resource unit occupied by the first radio resource block.

In one embodiment, the first signaling is used to indicate a time-frequency resource unit occupied by the first radio resource block.

In one embodiment, the first signaling is used to indicate spatial parameters adopted by the first radio resource block.

In one embodiment, the first signaling is used to indicate Spatial Transmission Parameters adopted by the first signal.

In one embodiment, the first signaling is used to indicate Spatial Reception Parameters adopted by the first signal.

In one embodiment, the first signaling is used to indicate a Modulation and Coding Scheme (MCS) adopted by the first signal.

In one embodiment, the first signaling is used to indicate a time-frequency resource unit occupied by the first radio resource block and an MCS adopted by the first signal.

In one embodiment, the first signaling is used to indicate a Demodulation Reference Signal (DMRS) adopted by the first signal.

In one embodiment, the first signaling is used to indicate transmit power adopted by the first signal.

In one embodiment, the first signaling is used to indicate a number of bits comprised in a first information block, and the first signal comprises the first information block.

In one embodiment, the first signaling indicates a Redundancy Version (RV) adopted by the first signal.

In one embodiment, a time-frequency resource unit occupied by the first signaling is used to determine a time-frequency resource unit occupied by the first radio resource block.

In one embodiment, transmit power of the first signaling is used to determine transmit power of the first signal.

In one embodiment, the first signal is used to trigger a transmission of the first signal.

In one embodiment, the first signaling is used to trigger a transmission of the first signal on the first radio resource block.

In one embodiment, the first signaling is used to activate a transmission of the first signal.

In one embodiment, the first signaling is used to activate a transmission of the first signal on the first radio resource block.

In one embodiment, the first signaling comprises at least one bit.

In one embodiment, the first signaling comprises one bit.

In one embodiment, the first signaling comprises two bits.

In one embodiment, the first signaling is used to indicate a configuration parameter of the first signal.

In one embodiment, the first signaling is used to indicate one of at least one first-type configuration parameter, any of the at least one first-type configuration parameter is a configuration parameter of the first signal, and the at least one first-type configuration parameter is configured by a higher-layer signaling.

In one embodiment, a configuration parameter of the first signal comprises a transmission period of the first signal.

In one embodiment, a configuration parameter of the first signal comprises a numerology of the first signal.

In one embodiment, a configuration parameter of the first signal comprises a Subcarrier Spacing (SCS) of a subcarrier occupied by the first signal.

In one embodiment, a configuration parameter of the first signal comprises a port number of the first signal.

In one embodiment, the first signaling is used to indicate a transmission period of the first signal.

In one embodiment, the first signaling is used to indicate a signal pattern of the first signal.

In one embodiment, the first signaling is used to indicate an Antenna Port (AP) of the first signal.

In one embodiment, the first signal comprises a resource indicator of the first signal.

In one embodiment, the first signaling comprises a CSI-RS Resource Indicator (CRI).

In one embodiment, the first signaling is transmitted through a Physical Sidelink Control Channel (PSCCH).

In one embodiment, the first signaling is transmitted through a Physical Downlink

Control Channel (PDCCH).

In one embodiment, the first signaling is transmitted through a Narrow band Physical Downlink Control Channel (NPDCCH).

In one embodiment, the first signaling is broadcast.

In one embodiment, the first signaling is groupcast.

In one embodiment, the first signaling is unicast.

In one embodiment, the first signaling is cell-specific.

In one embodiment, the first signaling is UE-specific.

In one embodiment, the first signaling is dynamically configured.

In one embodiment, the first signaling comprises one or more fields in a PHY layer signaling.

In one embodiment, the first signaling comprises one or more fields in a piece of Downlink Control Information (DCI).

In one embodiment, the first signaling comprises one or more fields in a piece of Sidelink Control Information (SCI).

In one embodiment, the first signaling is DCI.

In one embodiment, the first signaling is SCI.

In one embodiment, the first signaling only comprises SCI.

In one embodiment, the first signaling comprises all or part of a Multimedia Access Control (MAC) layer signaling.

In one embodiment, the first signaling comprises one or more fields in a MAC Control Element (CE).

In one embodiment, the first signaling comprises all or part of a higher-layer signaling.

In one embodiment, the first signaling comprises all or part of a Radio Resource Control (RRC) layer signaling.

In one embodiment, the first signaling comprises one or more fields in an RRC Information Element (IE).

In one embodiment, the first radio resource block comprises at least one time-domain resource unit in time domain.

In one embodiment, at least one time-domain resource unit comprised in the first radio resource block are consecutive in time.

In one embodiment, at least two time-domain resource units in at least one time-domain resource unit comprised in the first radio resource block are non-consecutive in time.

In one embodiment, the first radio resource block comprises at least one frequency-domain resource unit in frequency domain.

In one embodiment, at least one frequency-domain resource unit comprised in the first radio resource block are consecutive in frequency domain.

In one embodiment, at least two frequency-domain resource units in at least one frequency-domain resource unit comprised in the first radio resource block are non-consecutive in frequency domain.

In one embodiment, the first radio resource block comprises at least one time-frequency resource unit.

In one embodiment, at least one time-frequency resource unit comprised in the first radio resource block are consecutive in time domain.

In one embodiment, at least one time-frequency resource unit comprised in the first radio resource block are consecutive in frequency domain.

In one embodiment, at least two time-frequency resource units in at least one time-frequency resource unit comprised in the first radio resource block are non-consecutive in time domain.

In one embodiment, at least two time-frequency resource units in at least one time-frequency resource unit comprised in the first radio resource block are non-consecutive in frequency domain.

In one embodiment, the first radio resource block comprises at least one spatial-domain resource unit in spatial domain.

In one embodiment, the first radio resource block comprises a first spatial-domain resource unit group in spatial domain, and the first spatial-domain resource unit is one of at least one spatial-domain resource unit group.

In one embodiment, any of the at least one spatial-domain resource unit group comprises at least one spatial-domain resource unit.

In one embodiment, the first radio resource block belongs to sidelink spectrum.

In one embodiment, the first radio resource block belongs to uplink spectrum.

In one embodiment, the first radio resource block belongs to downlink spectrum.

In one embodiment, the first radio resource block belongs to unlicensed spectrum.

In one embodiment, the first radio resource block belongs to licensed spectrum.

In one embodiment, the first radio resource block belongs to V2X-specific spectrum.

In one embodiment, the first radio resource block belongs to a carrier.

In one embodiment, the first radio resource block belongs to a Bandwidth Part (BWP).

In one embodiment, the first radio resource block comprises a PSCCH.

In one embodiment, the first radio resource block comprises a Physical Sidelink Shared Channel (PSSCH).

In one embodiment, the first radio resource block comprises a Physical Sidelink Feedback Channel (PSFCH).

In one embodiment, the first radio resource block comprises a PSCCH and a PSSCH.

In one embodiment, the first radio resource block comprises a PSCCH and a PSFCH.

In one embodiment, the first radio resource block comprises a PSCCH, a PSSCH and a PSFCH.

In one embodiment, the first radio resource block comprises a Physical Uplink Control Channel (PUCCH).

In one embodiment, the first radio resource block comprises a Physical Uplink Shared Channel (PUSCH).

In one embodiment, the first radio resource block comprises a PUCCH and a PUSCH.

In one embodiment, the first radio resource block comprises a Physical Random Access Channel (PRACH) and a PUSCH.

In one embodiment, the first radio resource block comprises a Narrowband Physical Uplink Control Channel (NPUCCH).

In one embodiment, the first radio resource block comprises a Narrowband Physical Uplink Shared Channel (NPUSCH).

In one embodiment, the first radio resource block comprises an NPUCCH and an NPUSCH.

In one embodiment, the first signaling indicates a position of a frequency-domain resource unit of the first radio resource block.

In one embodiment, the first signaling indicates a start position of a frequency-domain resource unit occupied by the first radio resource block.

In one embodiment, the first signaling indicates a start position of a time-domain resource unit occupied by the first radio resource block.

In one embodiment, the first signaling indicates a time-domain interval of at least two time-domain resource units comprised in the first radio resource block.

In one embodiment, the first signaling indicates a time-domain interval between the at least two time-frequency resource units comprised in the first radio resource block.

In one embodiment, the time-domain interval comprises at least one time-domain resource unit.

In one embodiment, the time-domain interval comprises at least one multicarrier symbol.

In one embodiment, the time-domain interval comprises at least one slot.

In one embodiment, the time-domain interval comprises at least one subframe.

In one embodiment, the first signaling indicates a frequency-domain interval between the at least two time-frequency resource units comprised in the first radio resource block.

In one embodiment, the frequency-domain interval comprises at least one frequency-domain resource unit.

In one embodiment, the frequency-domain interval comprises at least one subchannel.

In one embodiment, the frequency-domain interval comprises at least one Physical Resource Block (PRB).

In one embodiment, the frequency-domain interval comprises at least one subcarrier.

In one embodiment, a time-frequency resource unit occupied by the first signaling is used to determine the first radio resource block.

In one embodiment, a time-domain resource unit occupied by the first signaling is used to determine a start position of the first radio resource block in time domain.

In one embodiment, the first signaling indicates the first spatial-domain resource unit group out of at least one spatial-domain resource unit group.

In one embodiment, the first signaling indicates an index of the first spatial-domain resource unit group in the at least one spatial-domain resource unit group.

In one embodiment, the first signal is cell-specific.

In one embodiment, the first signal is UE-specific.

In one embodiment, the first signal is broadcast.

In one embodiment, the first signal is groupcast.

In one embodiment, the first signal is unicast.

In one embodiment, the first signal is transmitted on the first radio resource block.

In one embodiment, the first signal is transmitted on the first radio resource block.

In one embodiment, the first signal occupies all time-domain resource units in the first radio resource block.

In one embodiment, the first signal occupies all frequency-domain resource units in the first radio resource block.

In one embodiment, the first signal occupies all time-frequency resource units in the first radio resource block.

In one embodiment, the first signal occupies partial time-domain resource units in the first radio resource block.

In one embodiment, the first signal occupies partial frequency-domain resource units in the first radio resource block.

In one embodiment, the first signal occupies partial time-frequency resource units in the first radio resource block.

In one embodiment, the first signal occupies a PSCCH and a PSSCH in the first radio resource block.

In one embodiment, the first signal occupies an NPUCCH and an NPUSCH in the first radio resource block.

In one embodiment, the first signal occupies a PSCCH in the first radio resource block.

In one embodiment, the first signal occupies an NPUSCH in the first radio resource block.

In one embodiment, the first signal comprises a first bit block, and the first bit block comprises at least one bit arranged in order.

In one embodiment, the first bit block comprises at least one Code Block (CB).

In one embodiment, the first bit block comprises at least one Code Block Group (CBG).

In one embodiment, the first bit block comprises one Transport Block (TB).

In one embodiment, the first bit block is acquired by a TB subjected to transport-block-level Cyclic Redundancy Check (CRC) attachment.

In one embodiment, the first bit block is a CB in a code block acquired by a TB sequentially subjected to transport-block-level CRC attachment, Code Block Segmentation, and code-block-level CRC attachment.

In one embodiment, the first signal is acquired after all or partial bits of the first bit block is sequentially subjected to transport-block-level CRC attachment, code block segmentation, code-block-level CRC attachment, channel coding, rate matching, code block concatenation, scrambling, modulation, layer mapping, antenna port mapping, mapping to physical resource blocks, baseband signal generation, modulation and upconversion.

In one embodiment, the first signal is an output after the first bit block is sequentially subjected to a modulation mapper, a layer mapper, precoding, a resource element mapper, and multicarrier symbol generation.

In one embodiment, the channel coding is based on a polar code.

In one embodiment, the channel coding is based on a Low-density Parity-Check (LDPC) code.

In one embodiment, only the first bit block is used to generate the first signal.

In one embodiment, there exists a bit block other than the first bit block being used to generate the first signal.

In one embodiment, the first signal comprises a third signaling, and the third signaling is used to indicate a transmission format of the first signal.

In one embodiment, the first signal comprises a third signaling, and the third signaling is used to indicate configuration information of the first signal.

In one embodiment, the third signaling is used to indicate an MCS adopted by the first signal.

In one embodiment, the third signaling is used to indicate a time-frequency resource unit occupied by the first radio resource block and an MCS adopted by the first signal.

In one embodiment, the third signaling is used to indicate a DMRS adopted by the first signal.

In one embodiment, the third signaling is used to indicate transmit power adopted by the first signal.

In one embodiment, the third signaling is used to indicate an RV adopted by the first signal.

In one embodiment, the third signaling is used to indicate a number of all bits comprised in the first bit block.

In one embodiment, the third signaling comprises one or more fields in SCI.

In one embodiment, the third signaling comprises one or more fields in Uplink Control Information (UCI).

In one embodiment, the third signaling is SCI.

In one embodiment, the third signaling is UCI.

In one embodiment, the third signaling comprises one or more fields in a Configured Grant.

In one embodiment, the third signaling is the Configured Grant.

In one embodiment, the definition of the Configured Grant refers to 3GPP TS38.214, section 6.1.2.3.

In one embodiment, the first signaling comprises the third signaling and the first bit block, and the third signaling is associated with the first bit block.

In one embodiment, the first bit block comprises a Channel State Information (CSI) report.

In one subembodiment, the first bit block comprises a Channel Quality Indicator (CQI) report.

In one embodiment, the first bit block comprises a Rank Indicator (RI) report.

In one embodiment, the first bit block comprises a Reference Signal Received Power (RSRP) report.

In one embodiment, the first bit block comprises a Reference Signal Received Quality (RSRQ) report.

In one embodiment, the first bit block comprises a Signal-to-Noise and Interference Ratio (SINR) report.

In one embodiment, the first bit block comprises data transmitted on a Sidelink Shared Channel (SL-SCH).

In one embodiment, the first bit block comprises data transmitted on a Sidelink Broadcast Channel (SL-BCH).

In one embodiment, the first bit block comprises data transmitted on a Downlink Shared Channel (DL-SCH).

In one embodiment, the first signal comprises Sidelink Feedback Information (SFI).

In one embodiment, the first signal comprises Hybrid Automatic Repeat request-Acknowledge (HARQ-ACK).

In one embodiment, the first signal comprises Hybrid Automatic Repeat request-Negative Acknowledge (HARQ-NACK).

In one embodiment, the first signal comprises a first-type reference signal.

In one embodiment, the first-type reference signal is used to measure a pathloss from a transmitter of the first-type reference signal to a receiver of the first-type reference signal.

In one embodiment, the first-type reference signal is used to measure receive power of a radio signal from a transmitter of the first-type reference signal.

In one embodiment, the first-type reference signal is used to measure RSRP of a radio signal from a transmitter of the first-type reference signal.

In one embodiment, the first-type reference signal is used to measure CSI of a radio signal from a transmitter of the first-type reference signal.

In one embodiment, the first-type reference signal is generated by a pseudo-random sequence.

In one embodiment, the first-type reference signal is generated by a Gold sequence.

In one embodiment, the first-type reference signal is generated by a M-sequence.

In one embodiment, the first-type reference signal is generated by a Zadeoff-Chu sequence.

In one embodiment, a generation method of the first-type reference signal refers to 3GPP TS38.211, section 7.4.1.5.

In one embodiment, the first-type reference signal comprises a Channel State Information Reference Signal (CSI-RS).

In one embodiment, the first-type reference signal comprises a Synchronization Signal (SS).

In one embodiment, the first-type reference signal comprises a Physical Random Access Channel (PRACH) Preamble.

In one embodiment, the first-type reference signal comprises a DMRS.

In one embodiment, the first-type reference signal comprises a Physical Uplink Control

Channel Demodulation Reference Signal (PUCCH DMRS).

In one embodiment, the first-type reference signal comprises a Physical Uplink Shared Channel Demodulation Reference Signal (PUSCH DMRS).

In one embodiment, the first-type reference signal comprises a Synchronization Signal/Physical Broadcast Channel Block (SS/PBCH Block).

In one embodiment, the first-type reference signal comprises a Sidelink Channel State Information Reference Signal (SL CSI-RS).

In one embodiment, the first-type reference signal comprises a Sidelink Synchronization Signal (SLSS).

In one embodiment, the first-type reference signal comprises a Primary Sidelink Synchronization Signal (PSSS).

In one embodiment, the first-type reference signal comprises a Secondary Sidelink Synchronization Signal (SSSS).

In one embodiment, the first-type reference signal comprises a Phase-Tracking Reference Signal (PT-RS).

In one embodiment, the first-type reference signal comprises a Sidelink Demodulation Reference Signal (SL DMRS).

In one embodiment, the first-type reference signal comprises a Physical Sidelink Broadcast Channel Demodulation Reference Signal (PSBCH DMRS).

In one embodiment, the first-type reference signal comprises a Physical Sidelink Control Channel Demodulation Reference Signal (PSCCH DMRS).

In one embodiment, the first-type reference signal comprises a Physical Sidelink Shared Channel Demodulation Reference Signal (PSSCH DMRS).

In one embodiment, the first-type reference signal comprises a Sidelink Synchronization Signal/Physical Broadcast Channel Block (SL SS/PBCH Block).

In one embodiment, a DMRS of the first signal does not belong to the first-type reference signal.

In one embodiment, the first signal comprises the first bit block and the first-type reference signal.

In one embodiment, the first signal comprises the first bit block, and the first signal does not comprise the first-type reference signal.

In one embodiment, the first signal does not comprise the first bit block, and the first signal comprises the first-type reference signal.

In one embodiment, the first signal comprises the third signaling, the first bit block and the first-type reference signal.

In one embodiment, the first signal comprises the third signaling and the first bit block, and the first signal does not comprise the first-type reference signal.

In one embodiment, the first signal does not comprise the third signaling and the first bit block, and the first signal comprises the first-type reference signal.

In one embodiment, the first signaling is used to trigger a transmission of the first-type reference signal on the first radio resource block.

In one embodiment, the first signaling is used to activate a transmission of the first-type reference signal on the first radio resource block.

In one embodiment, the first signaling is used to indicate a transmission of the first-type reference signal on the first radio resource block.

In one embodiment, the first signaling indicates whether the first signal comprises the first-type reference signal.

In one embodiment, the first signaling indicates that the first signal comprises the first-type reference signal.

In one embodiment, the first signaling indicates that the first signal does not comprise the first-type reference signal.

In one embodiment, the first signaling indirectly indicates whether the first signal comprises the first-type reference signal.

In one embodiment, the first signaling indirectly indicates that the first signal comprises the first-type reference signal.

### Embodiment 2

Embodiment 2 illustrates a schematic diagram of a network architecture according to the present disclosure, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230.

The EPS 200 may be interconnected with other access networks. For simple description, the entities/interfaces are not shown. As shown in FIG. 2, the EPS 200 provides packet switching services. Those skilled in the art will readily understand that various concepts presented throughout the present disclosure can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present disclosure comprises the UE 201.

In one embodiment, the second node in the present disclosure comprises the UE 241.

In one embodiment, the UE in the present disclosure comprises the UE 201.

In one embodiment, the UE in the present disclosure comprises the UE 241.

In one embodiment, the UE 201 supports sidelink communications.

In one embodiment, the UE 201 supports a PC5 interface.

In one embodiment, the UE 241 supports sidelink communications.

In one embodiment, the UE 241 supports a PC5 interface.

In one embodiment, a transmitter of the first signaling in the present disclosure comprises the UE 241.

In one embodiment, a receiver of the first signaling in the present disclosure comprises the UE 201.

In one embodiment, a transmitter of the second signaling in the present disclosure comprises the UE 201.

In one embodiment, a receiver of the second signaling in the present disclosure comprises the UE 241.

In one embodiment, a transmitter of the first signal in the present disclosure comprises the UE 201.

In one embodiment, a receiver of the first signal in the present disclosure comprises the UE 241.

### Embodiment 3

Embodiment 3 illustrates a schematic diagram of an example of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or RSU in V2X) and a second communication node (gNB, UE or RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signaling in the present disclosure is generated by the MAC 352.

In one embodiment, the first signaling in the present disclosure is generated by the PHY 351.

In one embodiment, the second signaling in the present disclosure is generated by the MAC 352.

In one embodiment, the second signaling in the present disclosure is generated by the PHY 351.

In one embodiment, the first signal in the present disclosure is generated by the SDAP sublayer 356.

In one embodiment, the first signal in the present disclosure is generated by the RRC sublayer 306.

In one embodiment, the first signal in the present disclosure is transmitted to the PHY 301 via the MAC sublayer 302.

In one embodiment, the first signal in the present disclosure is transmitted to the PHY 351 via the MAC sublayer 352.

### Embodiment 4

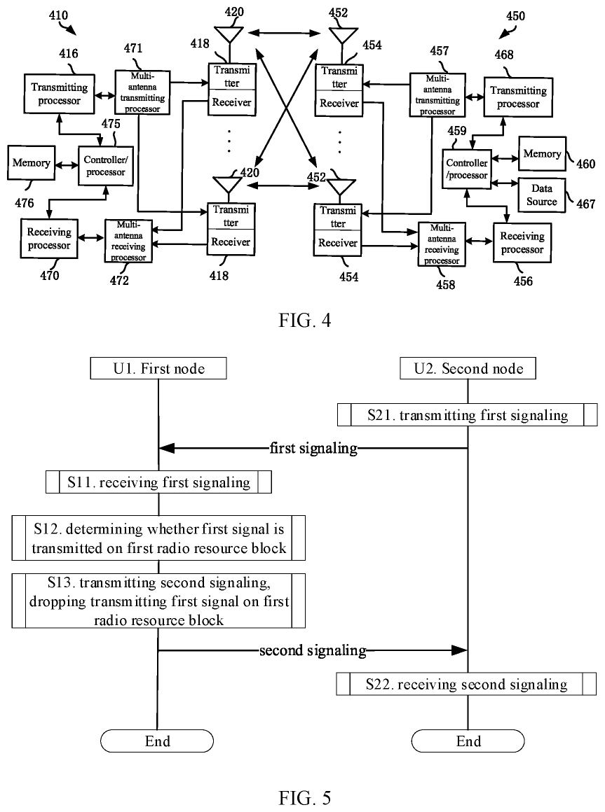

Embodiment 4 illustrates a schematic diagram of a first communication device and a second communication device in the present disclosure, as shown in FIG. 4. FIG. 4 is a block diagram of a first communication device 410 being in communications with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present disclosure comprises the second communication device 450, and the second node in the present disclosure comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling; transmits a second signaling, drops transmitting a first signal on a first radio resource block; or, drops transmitting a second signaling, transmits a first signal on a first radio resource block; the first signaling is used for a request for transmitting the first signal on the first radio resource block; and the first signaling is used to indicate a first radio resource block.

In one embodiment, the second communication device 450 comprises a memory that stores a computer readable instruction program. The computer readable instruction program generates an action when carried out by at least one processor. The action includes: receiving a first signaling; transmitting a second signaling, dropping transmitting a first signal on a first radio resource block; or, dropping transmitting a second signaling, transmitting a first signal on a first radio resource block; the first signaling is used for a request for transmitting the first signal on the first radio resource block; and the first signaling is used to indicate a first radio resource block.

In one embodiment, the first communication device 410 comprises at least one processor and at least one memory. The at least one memory comprises computer program codes;

the at least one memory and the computer program codes are configured to be used in collaboration with the at least one processor. The first communication device 410 at least: transmits a first signaling; and receives a second signaling, or, receives a first signal on a first radio resource block; the first signaling is used for a request for transmitting the first signal on the first radio resource block; and the first signaling is used to indicate a first radio resource block.

In one embodiment, the first communication device 410 comprises a memory that stores a computer readable instruction program. The computer readable instruction program generates an action when carried out by at least one processor. The action includes: transmitting a first signaling; and receiving a second signaling, or, receiving a first signal on a first radio resource block; the first signaling is used for a request for transmitting the first signal on the first radio resource block; and the first signaling is used to indicate a first radio resource block.

In one embodiment, at least one of the antenna 452, the receiver 454, the multi-antenna receiving processor 458, the receiving processor 456, the controller/processor 459, the memory 460, or the data source 467 is used to receive the first signaling in the present disclosure.

In one embodiment, at least one of the antenna 452, the transmitter 454, the multi-antenna transmitting processor 458, the transmitting processor 468, the controller/processor 459, the memory 460, or the data sources 467 is used to transmit the second signaling in the present disclosure.

In one embodiment, at least one of the antenna 452, the transmitter 454, the multi-antenna transmission processor 458, the transmitting processor 468, the controller/processor 459, the memory 460, or the data source 467 is used to transmit the first signal on the first radio resource block in the present disclosure.

In one embodiment, at least one of the antenna 452, the transmitter 454, the multi-antenna transmission processor 458, the transmitting processor 468, the controller/processor 459, the memory 460, or the data source 467 is used to determine whether the first signal is transmitted on the first radio resource block in the present disclosure.

In one embodiment, at least one of the antenna 452, the transmitter 454, the multi-antenna transmission processor 458, the transmitting processor 468, the controller/processor 459, the memory 460, or the data source 467 is used to transmit the first signal on the second radio resource block in the present disclosure.

In one embodiment, at least one of the antenna 420, the transmitter 418, the multi-antenna transmitting processor 471, the transmitting processor 416, the controller/processor 475, or the memory 476 is used to transmit the first signaling in the present disclosure.

In one embodiment, at least one of the antenna 420, the receiver 418, the multi-antenna receiving processor 472, the receiving processor 470, the controller/processor 475, or the memory 476 is used to receive the second signaling in the present disclosure.

In one embodiment, at least one of the antenna 420, the receiver 418, the multi-antenna receiving processor 472, the receiving processor 470, the controller/processor 475, or the memory 476 is used to receive the first signal on the first radio resource block in the present disclosure.

In one embodiment, at least one of the antenna 420, the receiver 418, the multi-antenna receiving processor 472, the receiving processor 470, the controller/processor 475, or the memory 476 is used to receive the first signal on the second radio resource block in the present disclosure.

### Embodiment 5

Embodiment 5 illustrates a flowchart of radio signal transmission according to one embodiment in the present disclosure, as shown in FIG. 5. In FIG. 5, a first node U1 and a second node U2 are in communications via an air interface.

The first node U1 receives a first signaling in step S11; determines whether a first signal is transmitted on a first radio resource in step S12; transmits a second signal, and drops transmitting a first signal on a first radio resource block in step S13.

The second node U2 transmits a first signaling in step S21; and receives a second signaling in step S22.

In embodiment 5, the first signaling is used for a request for transmitting the first signal on the first radio resource block; and the first signaling is used to indicate a first radio resource block; when it is determined to drop transmitting the first signal on the first radio resource block, the second signaling is transmitted by the first node U1; The second signaling is used to indicate that the first signaling is correctly received.

In one embodiment, the first node U1 receives a first signaling; the first node U1 transmits a second signaling, and the first node U1 drops transmitting a first signaling on a first radio resource block; the first signaling is used for a request for transmitting the first signal on the first radio resource block; and the first signaling is used to indicate a first radio resource block.

In one embodiment, the first node U1 receives a first signaling; the first node U1 drops transmitting a second signaling, and the first node U1 transmits a first signal on a first radio resource block; the first signaling is used for a request for transmitting the first signal on the first radio resource block; and the first signaling is used to indicate a first radio resource block.

In one embodiment, when it is determined to transmit the first signal on the first radio resource block, the second signaling is not transmitted;

In one embodiment, the first node U1 and the second node U2 are in communications via SL.

In one embodiment, the second signaling is used to indicate that the first signaling is correctly received, and the first node does not carry out the request in the first signaling.

In one embodiment, the second signaling is used to indicate that the first signaling is correctly received, and the first node drops executing the request in the first signaling.

In one embodiment, the request refers to transmitting the first signal on the first radio resource block.

In one embodiment, the second signaling is used to indicate that the first signaling is correctly received, and the first node does not transmit the first signal on the first radio resource block.

In one embodiment, the second signaling is used to indicate that the first signaling is correctly received, and the first node drops transmitting the first signal on the first radio resource block.

In one embodiment, the second signaling is transmitted through a PSCCH.

In one embodiment, the second signaling is transmitted through a PSSCH.

In one embodiment, the second signaling is transmitted through a PSFCH.

In one embodiment, the second signaling is transmitted through a PUCCH.

In one embodiment, the second signaling is transmitted through an NPDUCH.

In one embodiment, the second signaling is broadcast.

In one embodiment, the second signaling is groupcast.

In one embodiment, the second signaling is unicast.

In one embodiment, the second signaling is cell-specific.

In one embodiment, the second signaling is UE-specific.

In one embodiment, the second signaling is dynamically configured.

In one embodiment, the second signaling comprises one or more fields in a PHY layer signaling.

In one embodiment, the second signaling comprises one or more fields in a piece of SCI.

In one embodiment, the second signaling comprises a UCI embodiment, and the second signaling is DCI.

In one embodiment, the second signaling comprises all or part of a MAC layer signaling.

In one embodiment, the second signaling comprises one or more fields in a MAC CE.

In one embodiment, the second signaling comprises all or part of a higher-layer signaling.

In one embodiment, the second signaling comprises all or part of an RRC-layer signaling.

In one embodiment, the second signaling comprises one or more fields of an RRC IE.

In one embodiment, the second signaling comprises an SFI.

In one embodiment, the second signaling comprises a HARQ-ACK or a HARQ-NACK.

In one embodiment, the second signaling comprises a HARQ-ACK.

In one embodiment, the second signaling comprises a HARQ-NACK.

In one embodiment, the second signaling comprises a HARQ-ACK and a HARQ-NACK.

In one embodiment, the second signaling comprises a Sidelink HARQ-ACK (SL HARQ-ACK).

In one embodiment, the second signaling comprises a HARQ-NACK, and the second signaling does not comprise a HARQ-ACK.

In one embodiment, the second signaling comprises an SL HARQ-NACK, and the second signaling does not comprise an SL HARQ-ACK.

In one embodiment, the second signaling comprises a HARQ-ACK, and the second signaling does not comprise a HARQ-NACK.

In one embodiment, the second signaling comprises an SL HARQ-ACK, and the second signaling does not comprise an SL HARQ-NACK.

In one embodiment, the second signaling is used to determine that the first signaling is correctly received.

In one embodiment, the first signaling is correctly received, and the second signaling is transmitted.

In one embodiment, the first signaling is correctly received, the second signaling is transmitted, the first signal is dropped being transmitted on the first radio resource block.

In one embodiment, the first signaling is correctly received, the second signaling is transmitted, and the second signaling comprises a HARQ-NACK.

In one embodiment, the first signaling is correctly received, the second signaling is transmitted, and the second signaling comprises an SL HARQ-NACK.

In one embodiment, the first signaling is correctly received, the second signaling is transmitted, and the second signaling is a HARQ-NACK.

In one embodiment, the first signaling is correctly received, the second signaling is transmitted, and the second signaling comprises a first bit.

In one embodiment, the first bit is a binary bit.

In one embodiment, the first bit indicates HARQ information.

In one embodiment, the first bit indicates HARQ-NACK information.

In one embodiment, a value of the first bit is “0”.

In one embodiment, when the first signaling is correctly received, the second signaling is transmitted, and the second signaling comprises a HARQ-NACK; when the first signaling is not correctly received, the second signaling is not transmitted.

In one embodiment, the first signaling is correctly received, the second signaling is transmitted, and the second signaling comprises a HARQ-ACK.

In one embodiment, the first signaling is correctly received, the second signaling is transmitted, and the second signaling comprises an SL HARQ-ACK.

In one embodiment, the first signaling is correctly received, the second signaling is transmitted, and the second signaling is a HARQ-ACK.

In one embodiment, the first bit indicates HARQ-ACK information.

In one embodiment, a value of the first bit is “1”.

In one embodiment, when the first signaling is correctly received, the second signaling is transmitted, and the second signaling comprises a HARQ-ACK; when the first signaling is not correctly received, the second signaling is not transmitted.

In one embodiment, the first signaling is not correctly received, and the second signaling is not transmitted.

In one embodiment, the first signaling is not correctly received, the second signaling is not transmitted, and the first signal is not transmitted.

In one embodiment, the being correctly received includes: executing channel decoding on a radio signal, and a result of the executing channel decoding on a radio signal passes a CRC check.

In one embodiment, the being correctly received includes: executing an energy detection on the radio signal within a duration, and an average value of a result obtained by the executing an energy detection on the radio signal within a duration exceeds a first given threshold.

In one embodiment, the being correctly received includes: executing a coherent detection on the radio signal, and signal energy obtained from the executing a coherent detection on the radio signal exceeds a second given threshold.

In one embodiment, the first signaling being correctly received includes: a result obtained by executing channel decoding on the first signaling passes a CRC check.

In one embodiment, the first signaling being correctly received includes: a result obtained by performing a receive power detection on the first signaling is higher than a given receive power threshold.

In one embodiment, the first signaling being correctly received includes: an average value obtained by executing a plurality of receive power detections on the first signaling is higher than a given receive power threshold.

In one embodiment, the channel decoding is based on Viterbi algorithm.

In one embodiment, the channel decoding is based on iteration.

In one embodiment, the channel decoding is based on Belief Propagation (BP) algorithm.

In one embodiment, the channel decoding is based on Log Likelihood Ratio (LLR)-BP algorithm.

### Embodiment 6

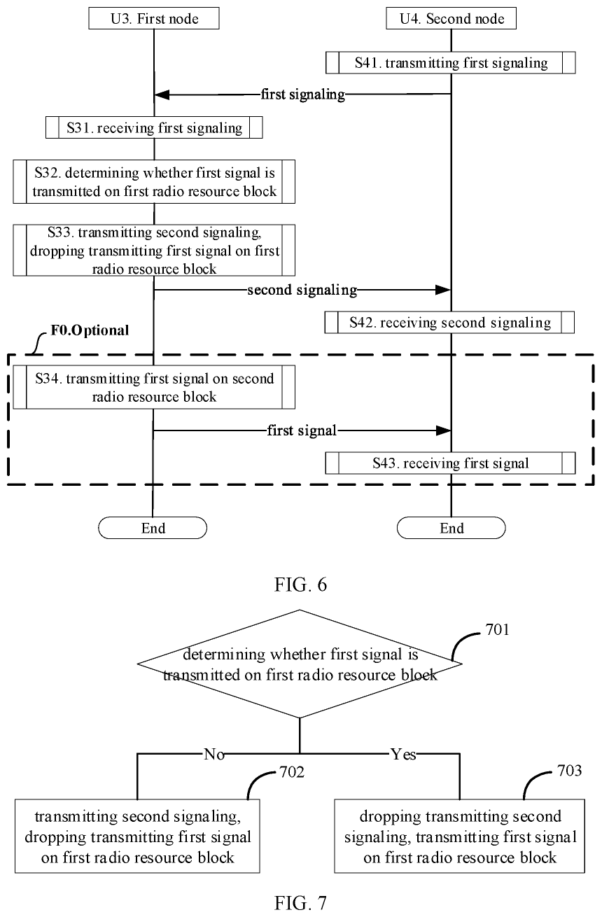

Embodiment 6 illustrates a flowchart of radio signal transmission according to one embodiment of the present disclosure, as shown in FIG. 6. In FIG. 6, a first node U3 and a second node U4 are in communications via an air interface. In FIG. 6, steps in dotted box F0 are optional.

The first node U3 receives a first signaling in step S31; determines whether a first signal is transmitted on a first radio resource in step S32; in step S33, transmits a second signal, and drops transmitting a first signal on a first radio resource block; and transmits a first signal on a second radio resource block in step S34.

The second node U4 transmits a first signaling in step S41; receives a second signaling in step S42; and receives a first signal in step S43.

In embodiment 6, the first signaling is used for a request for transmitting the first signal on the first radio resource block; and the first signaling is used to indicate a first radio resource block; when it is determined to drop transmitting the first signal on the first radio resource block, the second signaling is transmitted by the first node U3; the second signaling comprises first control information, the first control information is used to indicate a second radio resource block, and the second radio resource block is different from the first radio resource block.

In one embodiment, the first node U3 and the second node U4 are in communications via SL.

In one embodiment, steps in box F0 in FIG. 6 exist.

In one embodiment, when it is determined to drop transmitting the first signal on the first radio resource block, steps in box F0 in FIG. 6 exist.

In one embodiment, when the second signaling is transmitted by the first node U3, steps in box F0 in FIG. 6 exist.

In one embodiment, when the second signaling is transmitted by the first node U3, the second signaling comprises the first control information, and steps in box F0 in FIG. 6 exist.

In one embodiment, when it is determined to drop transmitting the first signal on the first radio resource block and the second signaling comprises the first control information, steps in box F0 in FIG. 6 exist.

In one embodiment, steps in box F0 in FIG. 6 do not exist.

In one embodiment, when it is determined to drop transmitting the first signal on the first radio resource block, the second signaling does not comprise the first control information, and steps in box F0 in FIG. 6 do not exist.

In one embodiment, when the second signaling is transmitted by the first node U3 and the second signaling does not comprise the first control information, steps in box F0 in FIG. 6 do not exist.

In one embodiment, the second radio resource block comprises at least one time-domain resource unit in time domain.

In one embodiment, the second radio resource block comprises at least one frequency-domain resource unit in frequency domain.

In one embodiment, the second radio resource block comprises at least one time-frequency resource unit.

In one embodiment, the second radio resource block belongs to an SL spectrum.

In one embodiment, the second radio resource block belongs to a UL spectrum.

In one embodiment, the second radio resource block belongs to a DL spectrum.

In one embodiment, the second radio resource block belongs to an unlicensed spectrum.

In one embodiment, the second radio resource block belongs to a licensed spectrum.

In one embodiment, the second radio resource block belongs to a V2X-specific spectrum.

In one embodiment, the second radio resource block belongs to a carrier.

In one embodiment, the second radio resource block belongs to a BWP.

In one embodiment, the second radio resource block comprises a PSCCH.

In one embodiment, the second radio resource block comprises a PSSCH.

In one embodiment, the second radio resource block comprises a PSFCH.

In one embodiment, the second radio resource block comprises a PSCCH and a PSSCH.

In one embodiment, the second radio resource block comprises a PSCCH and a PSFCH.

In one embodiment, the second radio resource block comprises a PSCCH, a PSSCH and a PSFCH.

In one embodiment, the second radio resource block comprises a PUCCH.

In one embodiment, the second radio resource block comprises a PUSCH.

In one embodiment, the second radio resource block comprises a PUCCH and a PUSCH.

In one embodiment, the second radio resource block comprises a PRACH and a PUSCH.

In one embodiment, the second radio resource block comprises an NPUCCH.

In one embodiment, the second radio resource block comprises an NPUSCH.

In one embodiment, the second radio resource block comprises an NPUCCH and an NPUSCH.

In one embodiment, the second radio resource block overlaps with the first radio resource block.

In one embodiment, the second radio resource block and the first radio resource block occupy at least two different time-domain resource units in time domain.

In one embodiment, the second radio resource block and the first radio resource block occupy at least two different frequency-domain resource units in frequency domain.

In one embodiment, the second radio resource block and the first radio resource block occupy at least two different time-frequency resource units.

In one embodiment, the second radio resource block is orthogonal to the first radio resource block.

In one embodiment, the second radio resource block is orthogonal to the first radio resource block in time domain.

In one embodiment, the second radio resource block is orthogonal to the first radio resource block in frequency domain.

In one embodiment, any time-domain resource unit in at least one time-domain resource unit comprised in the second radio resource block does not belong to the first radio resource block.

In one embodiment, any time-frequency resource unit in at least one time-frequency resource unit comprised in the second radio resource block does not belong to the first radio resource block.

In one embodiment, the second signaling comprises the first control information.

In one embodiment, the first control information comprises one or more fields of a PHY layer signaling.

In one embodiment, the first control information comprises one or more fields in a piece of Uplink Control Information (UCI).

In one embodiment, the first control information comprises one or more fields in a piece of SCI.

In one embodiment, the first control information is UCI.

In one embodiment, the first control information is SCI.

In one embodiment, the first control information only comprises SCI.

In one embodiment, the first control information comprises all or part of a MAC layer signaling.

In one embodiment, the first control information comprises one or more fields in a MAC CE.

In one embodiment, the first control information comprises all or part of a higher-layer signaling.

In one embodiment, the first control information comprises all or part of an RRC signaling.

In one embodiment, the first control information comprises one or more fields in an RRC IE.

In one embodiment, the first control information comprises scheduling information of the first signal.

In one embodiment, the first control information comprises a transmission format of the first signal.

In one embodiment, the first control information is used to indicate the second radio resource block.

In one embodiment, the first control information is used to indicate a time-domain resource unit occupied by the second radio resource block.

In one embodiment, the first control information is used to indicate a frequency-domain resource unit occupied by the second radio resource block.

In one embodiment, the first control information is used to indicate a time-frequency resource unit occupied by the second radio resource block.

In one embodiment, the first control information is used to indicate spatial parameters adopted by the second radio resource block.

In one embodiment, the first control information is used to indicate spatial transmission parameters adopted by the first signal.

In one embodiment, the first control information is used to indicate spatial reception parameters adopted by the first signal.

In one embodiment, the first control information is used to indicate an MCS adopted by the first signal.

In one embodiment, the first control information is used to indicate a time-frequency resource unit occupied by the second radio resource block and an MCS adopted by the first signal.

In one embodiment, the first control information is used to indicate a DMRS adopted by the first signal.

In one embodiment, the first control information is used to indicate transmit power adopted by the first signal.

In one embodiment, the first control information indicates an RV adopted by the first signal.

In one embodiment, a time-frequency resource unit occupied by the second signaling is used to determine a time-frequency resource unit occupied by the second radio resource block.

In one embodiment, transmit power of the second signaling is used to determine transmit power of the first signal.

In one embodiment, the second signal is used to trigger a transmission of the first signal.

In one embodiment, the second signaling is used to trigger a transmission of the first signal on the second radio resource block.

In one embodiment, the second signaling is used to activate a transmission of the first signal.

In one embodiment, the second signaling is used to activate a transmission of the first signal on the second radio resource block.

In one embodiment, the first control information comprises at least one bit.

In one embodiment, the first control information comprises one bit.

In one embodiment, the first control information comprises two bits.

In one embodiment, the first control information is used to indicate a configuration parameter of the first signal.

In one embodiment, the first control information is used to indicate one of at least one first-type configuration parameter, any of the at least one first-type configuration parameter is a configuration parameter of the first signal, and the at least one first-type configuration parameter is configured by a higher-layer signaling.

In one embodiment, the first control information is used to indicate a transmission period of the first signal.

In one embodiment, the first control information is used to indicate a signal pattern of the first signal.

In one embodiment, the first control information is used to indicate an AP of the first signal.

In one embodiment, the first control information comprises a resource indication of the first signal.

### Embodiment 7

Embodiment 7 illustrates a flowchart of determining whether a first signal is transmitted on a first radio resource block according to one embodiment of the present disclosure, as shown in FIG.7.

In Embodiment 7, in step 701, the first node determines whether a first signal is transmitted on the first radio resource block; when it is “no”, goes to step 702, transmits the second signaling, and drops transmitting the first signal on the first radio resource block; and when it is “yes”, goes to step 703, drops transmitting the second signaling, and transmits the first signal on the first radio resource block.

In one embodiment, when the first radio resource block is unavailable, it is determined that the first signal is not transmitted on the first radio resource block.

In one embodiment, when the first radio resource block is used for DL, it is determined that the first signal is not transmitted on the first radio resource block.

In one embodiment, when signal energy detected on at least one first-type time-frequency resource block is greater than a given threshold, it is determined that the first signal is not transmitted on the first radio resource block, the at least one first-type radio resource block corresponds to the first radio resource block, and the first radio resource block does not belong to the at least one first-type radio resource block.

In one embodiment, the at least one first-type radio resource block corresponding to the first radio resource block refers to that any of the at least one first-type radio resource block and the first radio resource block occupy a same frequency-domain resource unit, and time-domain resource units respectively occupied by any of the at least one first-type radio resource block and the first radio resource block are different.

In one embodiment, the at least one first-type radio resource block corresponding to the first radio resource block refers to that any of the at least one first-type radio resource block and the first radio resource block occupy a same spatial-domain resource unit, and time-domain resource units respectively occupied by any of the at least one first-type radio resource block and the first radio resource block are different.

In one embodiment, the at least one first-type radio resource block corresponding to the first radio resource block refers to that any of the at least one first-type radio resource block and the first radio resource block occupy a same time-domain resource unit, and spatial-domain resource units respectively occupied by any of the at least one first-type radio resource block and the first radio resource block are different.

### Embodiment 8

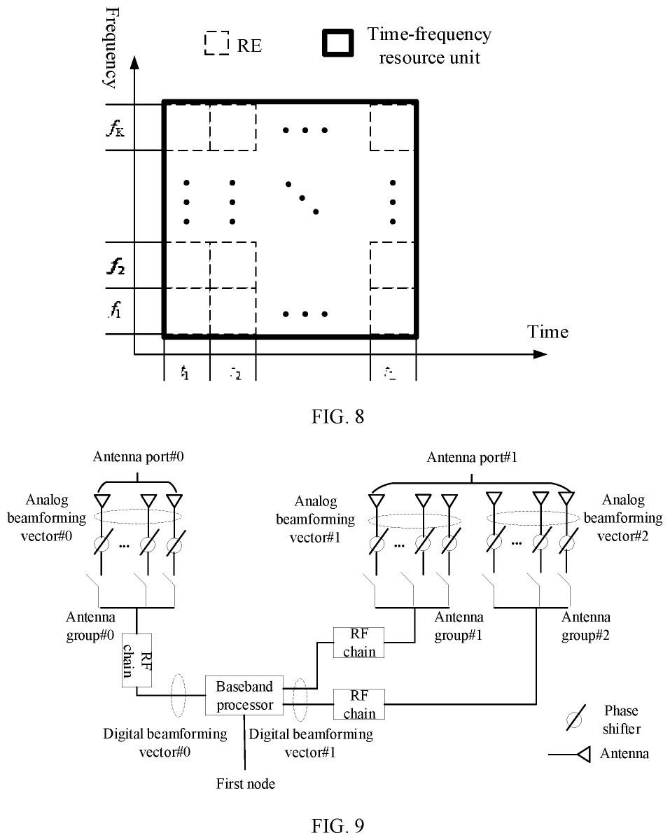

Embodiment 8 illustrates a schematic diagram of a time-frequency resource unit according to one embodiment of the present disclosure, as shown in FIG. 8. In FIG. 8, a dotted-line-framed small box represents a Resource Element (RE), and a solid-line-framed box represents a time-frequency resource unit. In FIG. 8, a time-frequency resource unit occupies K subcarrier(s) in frequency domain, and L multicarrier symbol(s) in time domain, K and L being positive integers. In FIG. 8, t₁, t₂, . . . , t_{L} represents(represent) the L symbol(s), and f₁, f₂, . . . , f_{K} represents(represent) the K subcarrier(s).

In Embodiment 8, a time-frequency resource unit occupies the K subcarrier(s) in frequency domain, and the L multicarrier symbol(s) in time domain, K and L being positive integers.

In one embodiment, K is equal to 12.

In one embodiment, K is equal to 72.

In one embodiment, K is equal to 127.

In one embodiment, K is equal to 240.

In one embodiment, L is equal to 1.

In one embodiment, L is equal to 2.

In one embodiment, L is not greater than 14.

In one embodiment, any of the L multicarrier symbol(s) is a Frequency Division

Multiple Access (FDMA) symbol.

In one embodiment, any of the L multicarrier symbol(s) is an Orthogonal Frequency

Division Multiplexing (OFDM) symbol.

In one embodiment, any of the L multicarrier symbol(s) is a Single Carrier-Frequency Division Multiple Access (SC-FDMA).

In one embodiment, any of the L multicarrier symbol(s) is a Discrete Fourier Transform Spread Orthogonal Frequency Division Multiplexing (DFT-S-OFDM) symbol.

In one embodiment, any of the L multicarrier symbol(s) is a Filter Bank Multicarrier (FBMC) symbol.

In one embodiment, any of the L multicarrier symbol(s) is an Interleaved Frequency Division Multiple Access (IFDMA) symbol.

In one embodiment, the time-domain resource unit comprises at least one radio frame.

In one embodiment, the time-domain resource unit comprises at least one subframe.

In one embodiment, the time-domain resource unit comprises at least one slot.

In one embodiment, the time-domain resource unit is a slot.

In one embodiment, the time-domain resource unit comprises at least one multicarrier symbol.

In one embodiment, the frequency-domain resource unit comprises at least one carrier.

In one embodiment, the frequency-domain resource unit comprises at least one Bandwidth Part (BWP).

In one embodiment, the frequency-domain resource unit is a BWP.

In one embodiment, the frequency-domain resource unit comprises at least one subchannel.

In one embodiment, the frequency-domain resource unit is a subchannel.

In one embodiment, any of the at least one subchannel comprises at least one Resource Block.

In one embodiment, the subchannel comprises at least one RB.

In one embodiment, any of the at least one RB comprises at least one sub-carrier in frequency domain.

In one embodiment, any of the at least one RB comprises 12 sub-carriers in frequency domain.

In one embodiment, the subchannel comprises at least one PRB.

In one embodiment, a number of PRB(s) comprised in the one subchannel is variable.

In one embodiment, any of the at least one PRB comprises at least one sub-carrier in frequency domain.

In one embodiment, any of the at least one PRB comprises 12 sub-carriers in frequency domain.

In one embodiment, the frequency-domain resource unit comprises at least one RB.

In one embodiment, the frequency-domain resource unit is an RB.

In one embodiment, the frequency-domain resource unit comprises at least one PRB.

In one embodiment, the frequency-domain resource unit is an PRB.

In one embodiment, the frequency-domain resource unit comprises at least one subcarrier.

In one embodiment, the frequency-domain resource unit is a subcarrier.

In one embodiment, the time-frequency resource unit comprises the time-domain resource unit.

In one embodiment, the time-frequency resource unit comprises the frequency-domain resource unit.

In one embodiment, the time-frequency resource unit comprises the time-domain resource unit and the frequency-domain resource unit.

In one embodiment, the time-frequency resource unit comprises R RE(s), R being a positive integer.

In one embodiment, the time-frequency resource unit consists of R RE(s), R being a positive integer.

In one embodiment, any of the R RE(s) occupies a multicarrier symbol in time domain and a subcarrier in frequency domain.

In one embodiment, the SCS is measured by Hertz (Hz).

In one embodiment, the SCS is measured by Kilohertz (kHz).

In one embodiment, the SCS is measured by Megahertz (MHz).

In one embodiment, a symbol length of the multicarrier symbol is measured by sampling point.

In one embodiment, a symbol length of the multicarrier symbol is measured by microsecond (μs).

In one embodiment, a symbol length of the multicarrier symbol is measured by millisecond (ms).

In one embodiment, the SCS is at least one of 1.25 kHz, 2.5 kHz, 5 kHz, 15 kHz, 30 kHz, 60 kHz, 120 kHz or 240 kHz.

In one embodiment, the time-frequency resource unit comprises the K subcarrier(s) and the L multicarrier symbol(s), and a product of K and L is not less than R.

In one embodiment, the time-frequency resource unit does not comprise an RE allocated to a Guard Period (GP).

In one embodiment, the time-frequency resource unit does not comprise a RE allocated to a Reference Signal (RS).

In one embodiment, the time-frequency resource unit comprises at least one RB.

In one embodiment, the time-frequency resource unit belongs to an RB.

In one embodiment, the time-frequency resource unit is equal to an RB in frequency domain.

In one embodiment, the time-frequency resource unit comprises 6 RBs in frequency domain.

In one embodiment, the time-frequency resource unit comprises 20 RBs in frequency domain.

In one embodiment, the time-frequency resource unit comprises at least one Physical Resource Block (PRB).

In one embodiment, the time-frequency resource unit belongs to a PRB.

In one embodiment, the time-frequency resource unit is equal to a PRB in frequency domain.

In one embodiment, the time-frequency resource unit comprises at least one Virtual Resource Block (VRB).

In one embodiment, the time-frequency resource unit belongs to a VRB.

In one embodiment, the time-frequency resource unit is equal to a VRB in frequency domain.

In one embodiment, the time-frequency resource unit comprises at least one PRB pair.

In one embodiment, the time-frequency resource unit belongs to a PRB pair.

In one embodiment, the time-frequency resource unit is equal to a PRB pair in frequency domain.

In one embodiment, the time-frequency resource unit comprises at least one radio frame.

In one embodiment, the time-frequency resource unit belongs to a radio frame.

In one embodiment, the time-frequency resource unit is equal to a radio frame in time domain.

In one embodiment, the time-frequency resource unit comprises at least one subframe.

In one embodiment, the time-frequency resource unit belongs to a subframe.

In one embodiment, the time-frequency resource unit is equal to a subframe in time domain.

In one embodiment, the time-frequency resource unit comprises at least one slot.

In one embodiment, the time-frequency resource unit belongs to a slot.

In one embodiment, the time-frequency resource unit is equal to a slot in time domain.

In one embodiment, the time-frequency resource unit comprises at least one Symbol.

In one embodiment, the time-frequency resource unit belongs to a Symbol.

In one embodiment, the time-frequency resource unit is equal to a Symbol in time domain.

In one embodiment, a duration of the time-domain resource unit in the present disclosure is equal to a duration of the time-frequency resource unit in the present disclosure in time domain.

In one embodiment, a number of subcarrier(s) occupied by the frequency-domain resource unit in the present disclosure is equal to a number of subcarrier(s) occupied by the time-frequency resource unit in the present disclosure in frequency domain.

### Embodiment 9

Embodiment 9 illustrates a schematic diagram of relations among antenna ports and antenna port groups according to one embodiment of the present disclosure, as shown in FIG. 9.

In Embodiment 9, an antenna port group comprises at least one antenna port; one antenna port is formed by superposition of antennas in at least one antenna group through antenna virtualization; an antenna group comprises at least one antenna. An antenna group is connected to a baseband processor via a Radio Frequency (RF) chain, and different antenna groups correspond to different RF chains. A given antenna port is one antenna port in the one antenna port group; mapping coefficients from all antennas of at least one antenna group comprised in the given antenna port to the given antenna port constitute a beamforming vector corresponding to the given antenna port. Mapping coefficients from multiple antennas comprised in any given antenna group within at least one antenna group comprised in the given antenna port to the given antenna port constitute an analog beamforming vector of the given antenna group. Analog beamforming vectors corresponding to the at least one antenna group comprised in the given antenna port are arranged diagonally to form an analog beamforming matrix corresponding to the given antenna port. Mapping coefficients from the at least one antenna group comprised in the given antenna port to the given antenna port constitute a digital beamforming vector corresponding to the given antenna port. A beamforming vector corresponding to the given antenna port is acquired as a product of the analog beamforming matrix and the digital beamforming vector corresponding to the given antenna port.

FIG. 9 illustrates two antenna ports, namely, antenna port #0 and antenna port #1. Herein, the antenna port #0 consists of antenna group #0, and the antenna port #1 consists of antenna group #1 and antenna group #2. Mapping coefficients from multiple antennas of the antenna group #0 to the antenna port #0 constitute an analog beamforming vector #0; mapping coefficients from the antenna group #0 to the antenna port #0 constitute a digital beamforming vector #0; a beamforming vector corresponding to the antenna port #0 is acquired as a product of the analog beamforming vector #0 and the digital beamforming vector #0. Mapping coefficients from multiple antennas of the antenna group #1 and multiple antennas of the antenna group #2 to the antenna port #1 respectively constitute an analog beamforming vector #1 and an analog beamforming vector #2; and mapping coefficients from the antenna group #1 and the antenna group #2 to the antenna port #1 constitute a digital beamforming vector #1. A beamforming vector corresponding to the antenna port #1 is acquired as a product of an analog beamforming matrix formed by the analog beamforming vector #1 and the analog beamforming vector #2 arranged diagonally and the digital beamforming vector #1.

In one embodiment, one antenna port only comprises one antenna group, i.e., one RF chain, for instance, the antenna port #0 in FIG. 9.

In one subembodiment of the above embodiment, the analog beamforming matrix corresponding to the one antenna port is subjected to dimensionality reduction to form an analog beamforming vector, and the digital beamforming vector corresponding to the one antenna port is subjected to dimensionality reduction to form a scaler, a beamforming vector corresponding to the one antenna port is equal to an analog beamforming vector corresponding thereto. For example, the antenna port #0 in FIG. 9 only comprises the antenna group #0, the digital beamforming vector #0 in FIG. 9 is subjected to dimensionality reduction to form a scaler, a beamforming vector corresponding to the antenna port #0 is the analog beamforming vector #0.

In one embodiment, one antenna port comprises at least one antenna group, that is, at least one RF chain, for example, the antenna port #1 in FIG. 9.

In one embodiment, one antenna port is an antenna port; the specific definition of the antenna port can be found in 3GPP TS36.211, section 5.2 and 6.2, or 3GPP TS38.211, section 4.4.

In one embodiment, small-scale channel parameters that a radio signal transmitted on one antenna port goes through can be used to infer small-scale channel parameters that another radio signal transmitted on the antenna port goes through.

In one subembodiment of the above embodiment, the small-scale channel parameters include one or more of a Channel Impulse Response (CIR), a Precoding Matrix Indicator (PMI), a Channel Quality Indicator (CQI), and a Rank Indicator (RI).

In one embodiment, two antennas being Quasi Co-Located (QCL) refers to: all or partial large-scale properties of a radio signal transmitted on one of the two antenna ports can be used to infer all or partial large-scale properties of a radio signal transmitted on the other one of the two antenna ports.

In one embodiment, the large-scale properties of a radio signal include one or more of delay spread, Doppler spread, Doppler shift, average gain, average delay, and spatial Rx parameters.

In one embodiment, the specific meaning of the QCL can be found in 3GPP TS36.211, section 6.2, 3GPP TS38.211, section 4.4 or 3GPP TS38.214, section 5.1.5.

In one embodiment, a QCL type between two antenna ports being QCL-TypeD refers to: Spatial Rx parameters of a radio signal transmitted on the one antenna port can be used to infer Spatial Rx parameters of a radio signal transmitted on the other antenna port.

In one embodiment, a QCL type between two antenna ports being QCL-TypeD refers to:

a radio signal transmitted by the one antenna port and a radio signal transmitted by the other antenna port can be received with same Spatial Rx parameters.

In one embodiment, the specific meaning of the QCL-TypeD can be found in 3GPP TS38.214, section 5.1.5.

In one embodiment, Spatial Rx parameters comprise one or more of a receiving beam, a receiving analog beamforming matrix, a receiving analog beamforming vector, a receiving digital beamforming vector, a receiving beamforming vector, and a Spatial Domain Reception Filter.

In one embodiment, Spatial Tx parameters comprise one or more of a transmitting beam, a transmitting analog beamforming matrix, a transmitting analog beamforming vector, a transmitting digital beamforming vector, a transmitting beamforming vector and a Spatial Domain Transmission Filter.

In one embodiment, the spatial-domain resource unit corresponds to at least one spatial transmission parameter.

In one embodiment, the spatial-domain resource unit corresponds to a spatial transmission parameter.

In one embodiment, the spatial-domain resource unit comprises at least one spatial transmission parameter.

In one embodiment, the spatial-domain resource unit comprises a spatial transmission parameter.

In one embodiment, the spatial-domain resource unit corresponds to at least one antenna port group.

In one embodiment, any spatial transmission parameter in the spatial-domain resource unit corresponds to an antenna port group.

In one embodiment, the spatial-domain resource unit corresponds to an antenna port group.

In one embodiment, the spatial-domain resource unit corresponds to an antenna port.

In one embodiment, the spatial-domain resource unit corresponds to at least one spatial-domain transmission filter.

In one embodiment, the spatial-domain resource unit corresponds to a spatial-domain transmission filter.

In one embodiment, the spatial-domain resource unit comprises at least one spatial-domain transmission filter.

In one embodiment, the spatial-domain resource unit comprises a spatial-domain transmission filter.

In one embodiment, the spatial-domain resource unit is a spatial-domain transmission filter.

### Embodiment 10

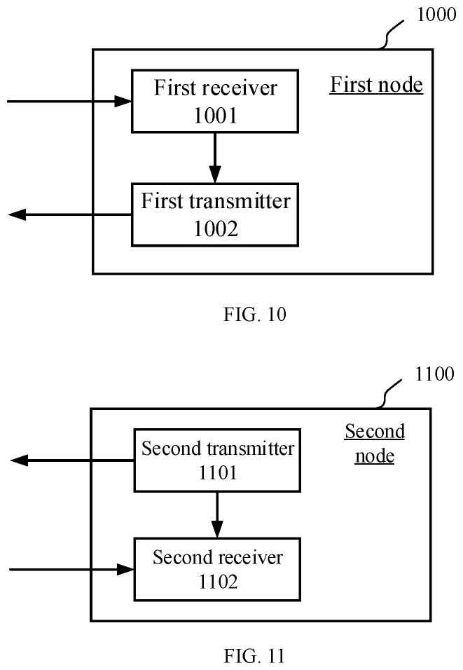

Embodiment 10 illustrates a structure block diagram of a processing device in a first node, as shown in FIG. 10. In embodiment 10, a processing device 1000 of a first node is mainly composed of a first receiver 1001 and a first transmitter 1002.

In one embodiment, the first receiver 1001 comprises at least one of the antenna 452, the transmitter/receiver 454, the multi-antenna receiving processor 458, the receiving processor 456, the controller/processor 459, the memory 460 or the data source 467 in FIG. 4 of the present disclosure.

In one embodiment, the first transmitter 1002 comprises at least one of the antenna 452, the transmitter/receiver 454, the multi-antenna transmitting processor 457, the transmitting processor 468, the controller/processor 459, the memory 460, or the data source 467 in FIG. 4 of the present disclosure.

In embodiment 10, the first receiver 1001 receives a first signaling; the first transmitter 1002 transmits a second signaling, drops transmitting a first signal on a first radio resource block; or, the first transmitter 1002 drops transmitting a second signaling, and transmits a first signal on a first radio resource block; the first signaling is used for a request for transmitting the first signal on the first radio resource block; and the first signaling is used to indicate a first radio resource block.

In one embodiment, the first transmitter 1002 determines whether the first signal is transmitted on the first radio resource block; when the first transmitter 1002 determines to transmit the first signal on the first radio resource block, the second signaling is not transmitted by the first transmitter 1002; when the first transmitter 1002 determines to drop transmitting the first signal on the first radio resource block, the second signaling is transmitted by the first transmitter 1002.

In one embodiment, the second signaling is used to indicate that the first signaling is correctly received.

In one embodiment, the first transmitter 1002 transmits the first signal on a second radio resource block; the second signaling comprises first control information, the first control information is used to indicate a second radio resource block, and the second radio resource block is different from the first radio resource block.

In one embodiment, the first node 1000 is a UE.

In one embodiment, the first node 1000 is a relay node.

In one embodiment, the first node 1000 is a base station.

In one embodiment, the first node 1000 is a vehicle-mounted communication device.

In one embodiment, the first node 1000 is a UE supporting V2X communications.

In one embodiment, the first node 1000 is a relay node supporting V2X communications.

Embodiment 11

Embodiment 11 illustrates a structure block diagram of a processing device in a second node, as shown in FIG. 11. In FIG. 11, a processing device 1100 of a second node is mainly composed of a second transmitter 1101 and a second receiver 1102.

In one embodiment, the second transmitter 1101 comprises at least one of the antenna 420, the transmitter/receiver 418, the multi-antenna transmitting processor 471, the transmitting processor 416, the controller/processor 475 or the memory 476 in FIG. 4 of the present disclosure.

In one embodiment, the second receiver 1102 comprises at least one of the antenna 420, the transmitter/receiver 418, the multi-antenna receiving processor 472, the receiving processor 470, the controller/processor 475 or the memory 476 in FIG. 4 of the present disclosure.

In embodiment 11, the second transmitter 1101 transmits a first signaling; the second receiver 1102 receives a second signaling; or, the second receiver 1102 receives a first signal on a first radio resource block; the first signaling is used for a request for transmitting the first signal on the first radio resource block; and the first signaling is used to indicate a first radio resource block.

In one embodiment, when the second signaling is received by the second receiver 1102, the second receiver 1102 drops receiving the first signal on the first radio resource block.

In one embodiment, when the second signaling is received by the second receiver 1102, a re-request for transmitting the first signal is dropped.

In one embodiment, the request of transmitting the first signal comprises scheduling the first signal.

In one embodiment, the request of transmitting the first signal comprises triggering a transmission of the first signal.

In one embodiment, the request of transmitting the first signal comprises activating a transmission of the first signal.

In one embodiment, the second signaling is used to indicate that the first signaling is correctly received.

In one embodiment, the second receiver 1102 receives the first signal on a second radio resource block; the second signaling comprises first control information, the first control information is used to indicate a second radio resource block, and the second radio resource block is different from the first radio resource block.

In one embodiment, the second node 1100 is a UE.

In one embodiment, the second node 1100 is a base station.

In one embodiment, the second node 1100 is a relay node.

In one embodiment, the second node 1100 is a UE supporting V2X communications.

In one embodiment, the second node 1100 is a base station supporting V2X communications.

In one embodiment, the second node 1100 is a relay node supporting V2X communications.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present disclosure includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A method in a first node for wireless communications, comprising:
receiving a first signaling;
transmitting a second signaling, dropping transmitting a first signal on a first radio resource block; or,
dropping transmitting a second signaling, transmitting a first signal on a first radio resource block;
wherein the first signaling is used for a request for transmitting the first signal on the first radio resource block; and the first signaling is used to indicate a first radio resource block; when it is determined to transmit the first signal on the first radio resource block, the second signaling is not transmitted; and when it is determined to drop transmitting the first signal on the first radio resource block, the second signaling is transmitted.

2. The method according to claim 1, wherein the second signaling is used to indicate that the first signaling is correctly received.

3. The method according to claim 2, wherein the first node does not carry out the request in the first signaling, or, the first node does not transmit the first signal on the first radio resource block.

4. The method according to claim 1, comprising:
transmitting the first signal on a second radio resource block;
wherein the second signaling comprises first control information, the first control information is used to indicate a second radio resource block, and the second radio resource block is different from the first radio resource block.

5. The method according to claim 2, comprising:
transmitting the first signal on a second radio resource block;
wherein the second signaling comprises first control information, the first control information is used to indicate a second radio resource block, and the second radio resource block is different from the first radio resource block.

6. A method in a second node for wireless communications, comprising:
transmitting a first signaling; and
receiving a second signaling, or, receiving a first signal on a first radio resource block;
wherein the first signaling is used for a request for transmitting the first signal on the first radio resource block; and the first signaling is used to indicate a first radio resource block; when the second signaling is received, receiving the first signal on the first radio resource block is dropped.

7. The method according to claim 6, wherein the second signaling is used to indicate that the first signaling is correctly received.

8. The method according to claim 7, wherein when the second signaling is received, a re-request for transmitting the first signal is dropped, or, a target receiver of the first signaling does not carry out the request in the first signaling.

9. The method according to claim 6, comprising:
receiving the first signal on a second radio resource block;
wherein the second signaling comprises first control information, the first control information is used to indicate a second radio resource block, and the second radio resource block is different from the first radio resource block.

10. The method according to claim 7, comprising:
receiving the first signal on a second radio resource block;
wherein the second signaling comprises first control information, the first control information is used to indicate a second radio resource block, and the second radio resource block is different from the first radio resource block.

11. A first node for wireless communications, comprising:
a first receiver, receiving a first signaling;
a first transmitter, transmitting a second signaling, dropping transmitting a first signal on a first radio resource block; or,
dropping transmitting a second signaling, transmitting a first signal on a first radio resource block;
wherein the first signaling is used for a request for transmitting the first signal on the first radio resource block; the first signaling is used to indicate a first radio resource block; when it is determined to transmit the first signal on the first radio resource block, the second signaling is not transmitted; and when it is determined to drop transmitting the first signal on the first radio resource block, the second signaling is transmitted.

12. The first node according to 11, wherein the second signaling is used to indicate that the first signaling is correctly received.

13. The method according to claim 12, wherein the first node does not carry out the request in the first signaling, or, the first node does not transmit the first signal on the first radio resource block.

14. The first node according to claim 11, comprising:
the first transmitter, transmitting the first signal on a second radio resource block;
wherein the second signaling comprises first control information, the first control information is used to indicate a second radio resource block, and the second radio resource block is different from the first radio resource block.

15. The first node according to claim 12, comprising:
the first transmitter, transmitting the first signal on a second radio resource block;
wherein the second signaling comprises first control information, the first control information is used to indicate a second radio resource block, and the second radio resource block is different from the first radio resource block.

16. A second node for wireless communications, comprising:
a second transmitter, transmitting a first signaling; and
a second receiver, receiving a second signaling, or, receiving a first signal on a first radio resource block;
wherein the first signaling is used for a request for transmitting the first signal on the first radio resource block; the first signaling is used to indicate a first radio resource block; when the second signaling is received by the second receiver, the second receiver drops receiving the first signal on the first radio resource block.

17. The second node according to 16, wherein the second signaling is used to indicate that the first signaling is correctly received.

18. The method according to claim 17, wherein when the second signaling is received, a re-request for transmitting the first signal is dropped, or, a target receiver of the first signaling does not carry out the request in the first signaling.

19. The second node according to claim 16, comprising:
the second receiver, receiving the first signal on a second radio resource block;
wherein the second signaling comprises first control information, the first control information is used to indicate a second radio resource block, and the second radio resource block is different from the first radio resource block.

20. The second node according to claim 17, comprising:
the second receiver, receiving the first signal on a second radio resource block;
wherein the second signaling comprises first control information, the first control information is used to indicate a second radio resource block, and the second radio resource block is different from the first radio resource block.
